(19) United States
(12) Patent Application Publication
(10) Pub. No.: US 2008/0060671 A1
(43) Pub. Date: Mar. 13, 2008

(54) Cleaning and drying system for a personal hygiene device

(76) Inventor: Stephen Ruffin, Decatur, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/899,774

(22) Filed: Sep. 7, 2007

Related U.S. Application Data
(60) Provisional application No. 60/824,860, filed on Sep. 7, 2006.

(51) Int. Cl. A45D 27/00; A45D 27/46; A45D 27/48; B26B 21/40; B65D 25/00

(52) U.S. Cl. 132/292; 220/501; 30/537

(57) ABSTRACT

An apparatus, system and method to clean and dry a personal hygiene device, such as a razor, tweezers, a comb, a toothbrush or other dental apparatuses, such as a dental pick. Typically, the system includes dryer generally coupled to a curved-wall chamber. The dryer generally includes a housing coupled to a duct, which, in turn is coupled to the curved-wall chamber. The housing includes a fan for pulling intake air into a housing via an air-intake. The housing further may include a heating element for heating air before entry into the curved-wall chamber. Thus, a personal hygiene device placed into a curved-wall chamber having a cleaning fluid can advantageously be cleaned and dried via circulating heated air and fluid within the curved-wall chamber under the circulation force of air provided by the fan.

### RELATED APPLICATIONS

The present United States Non-Provisional utility application is related to, and hereby claims priority to, and the full benefit of, U.S. Provisional application entitled Cleaning And Drying System For Shaving Razor, having assigned Ser. No. 60/824,860, filed Sep. 7, 2006, on behalf of Stephen Ruffin, incorporated herein by reference.

### BACKGROUND

I. Field of the Invention

The present invention relates generally to the field of personal hygiene devices including shaving razors, and more specifically to a cleaning and drying system for such personal hygiene devices.

II. Description of the Related Art.

Shaving razors are very well-known for use by men and women for shaving various body parts. Through regular shaving, blades naturally become dull and unsharpened from use. Furthermore, when razors are left with moisture on the blades, premature corrosion can occur. Additionally, debris, such as hair, shaving cream, soap and residue is often left on the blades of the razor. After use, corrosion and debris remaining on the blades can cause dullness and imperfections on the blade, as well as rust and the like.

### SUMMARY

In general, the invention features an apparatus, system and method to clean and dry a razor. In general, the system includes a dryer generally coupled to a curved-wall chamber. The dryer generally includes a housing coupled to a duct, which, in turn is coupled to a curved-wall chamber. The housing typically includes a fan for pulling intake air into the housing via an air-intake. Furthermore, the housing typically includes a heating element for heating air before entry into the curved-wall chamber. A razor placed into the curved-wall chamber having a cleaning fluid can advantageously be cleaned and dried via circulating air and fluid within the curved-wall chamber under the circulation force of the air provided by the fan. Additionally, the inventive apparatus hereof may in some preferred or alternative embodiments also be used for cleaning and drying other personal hygiene devices, such as combs, tooth brushes, tweezers and other dental devices, such as dental picks.

In general, the invention features a razor maintenance system, including a central housing having a first end and a second end, a duct coupled to the housing and a razor chamber coupled to the duct.

In one implementation and or embodiment of the invention hereof, the system further includes an intake vent disposed on the first end of the central housing and a fan positioned inside the central housing adjacent to the intake vent. The fan draws air external to the housing, into the housing.

In another implementation, the system further includes a heating element positioned adjacent to the second end of the central housing adjacent to a coupling point to the duct.

In another implementation, the duct has a first end and a second end, the first end of the duct is coupled to a second end of the central housing.

In another implementation, the system further includes an airflow pathway from the central housing to the duct.

In another implementation, the first end of the duct has a first area R and the second end of the duct has a second area a.

In still another implementation, R is greater than a.

In yet another implementation, R is equal to a.

In another implementation, the duct is a contraction duct.

In another implementation, the system further includes an exhaust vent disposed on a coupling point between the second end of the duct and the razor chamber.

In another implementation, the airflow pathway is defined from the intake vent, through the central housing, into the duct and through the exhaust vent.

In another implementation, the razor chamber is a curved-wall chamber.

In another implementation, the razor chamber comprises a razor slot for receiving a razor for positioning within the razor chamber.

In another implementation, the system further includes a passive air exit disposed on the razor chamber.

In another implementation, the system further includes a vane disposed on a lower interior surface of the razor chamber for receiving a razor head.

In another implementation, the airflow pathway is defined from the intake vent, through the central housing, into the duct, through the exhaust vent, and through a generally circular pattern along an interior wall of the razor chamber.

In another implementation, a razor positioned in the razor chamber includes a razor head positioned adjacent the exhaust vent interfering with the air flow pathway.

In another aspect, the invention features a razor drying and cleaning kit, including a razor; and a cleaning and drying razor apparatus for receiving the razor.

In one implementation, the kit further includes fluid for placement into the cleaning and drying razor apparatus.

In another implementation, the razor is for submersion into the fluid within the cleaning and drying razor apparatus.

In another implementation, the kit further includes a forced airflow pathway generated from the cleaning and drying razor apparatus and into a razor head disposed within the cleaning and drying razor apparatus for cleaning the razor head.

In another implementation, the forced airflow pathway is for evaporating the fluid within the cleaning and drying razor apparatus.

In another aspect, the invention features a cleaning and drying razor apparatus, including a housing, means for providing an airflow, disposed within the housing, means for providing heat into the airflow, disposed within the housing, a chamber for cleaning and drying a razor disposed within the chamber, the chamber being coupled to the housing and means for directing the airflow from the housing into the chamber.

In one preferred implementation, the apparatus further includes means to alter the airflow disposed between the housing and the chamber.

In another preferred implementation, the curved-wall chamber has a constant width. The width of the curved-wall chamber is only slightly greater than the width of the head of a shaving razor.

In another preferred implementation, the curved-wall chamber has side walls to contain the fluid.

In another preferred implementation, a debris filter is disposed within the curved-wall chamber preferably having the debris filter extend across the entire width of the curved wall chamber.

In another preferred implementation, the curved-wall chamber contains a rectangular slot aperture disposed therein whereby the handle of the user placed shaving razor protrudes. Preferably, the height of the rectangular slot is slightly greater than the height of the head of the shaving razor.

In another preferred implementation, the contraction duct consists of a rectangular cross section whereby attachment occurs between the curved-wall chamber and the circular cross section of the powered dryer portion of the duct. Specifically, the width of the rectangular end is preferably the same width as the curved-wall chamber.

In another implementation, a debris filter which may take various forms in different preferred and alternative embodiments can be added for trapping unwanted debris. Furthermore, it is appreciated that the debris filter can optionally be removed for cleaning and replacement.

One advantage of the invention is that thorough drying of the razor after use is provided.

Another advantage of the invention is that the cleaning and drying system provides removal of debris on blades of the razor.

Another advantage of the invention is that thorough drying of the razor can reduce corrosion of the blades.

Another advantage of the invention is that regular use of the system and method can extend the useful life of a razor.

Another advantage of the invention is that regular use of the system and method can improve the effectiveness of hair removal using a razor treated by the system and method.

Other objects, advantages and capabilities of the invention are apparent from the following description taken into conjunction with the accompanying drawings showing the preferred embodiment of the invention.

### BRIEF DESCRIPTION OF THE DRAWING

FIG. 1 illustrates a rear angle perspective view of a razor drying system.

FIG. 2 illustrates a side view of a razor drying system.

FIG. 3 illustrates a detailed rear angle perspective view of a razor drying system.

FIG. 4 illustrates a detailed side view of a razor drying system.

### DETAILED DESCRIPTION

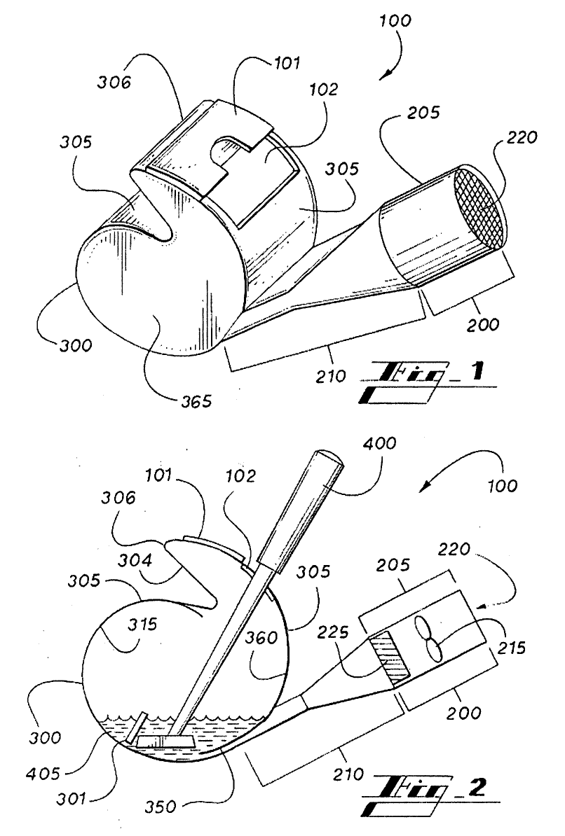

Referring to the Drawing, wherein like reference numerals designate corresponding parts throughout the several figures, reference is made first to FIG. 1 that illustrates a rear angle perspective view of a razor drying system100. Razor drying system 100 includes siding slot door 101, slot aperture 102, curved-wall chamber 300, side walls 365, contraction duct 210 and dryer 200 including a housing 205 having an air-intake 220. Additionally, the front of the razor drying system 100 includes an air exhaust aperture 304, which is disposed generally above the extent of the spiraling, continuous wall 305 and which extends upwardly towards or to lip 306 for exhausting air therethrough. As would be appreciated by those skilled in the art, air exhaust aperture 304 may take various different sizes and/or shapes consistent with its purpose simultaneously to permit the exhausting of air therethrough, but also to prevent cleaning fluid 405 from being splattered outwardly from air exhaust aperture 304.

FIG. 2 illustrates a side view of razor drying system 100 illustrating the details of operation of certain preferred embodiments, and it which razor drying system 100 includes slot door 101, curved-wall chamber 300, debris filter 301, cleaning fluid 405, contraction duct 210, dryer 200, air intake 220, heating element 225, and fan 215, as described in greater detail hereinbelow.

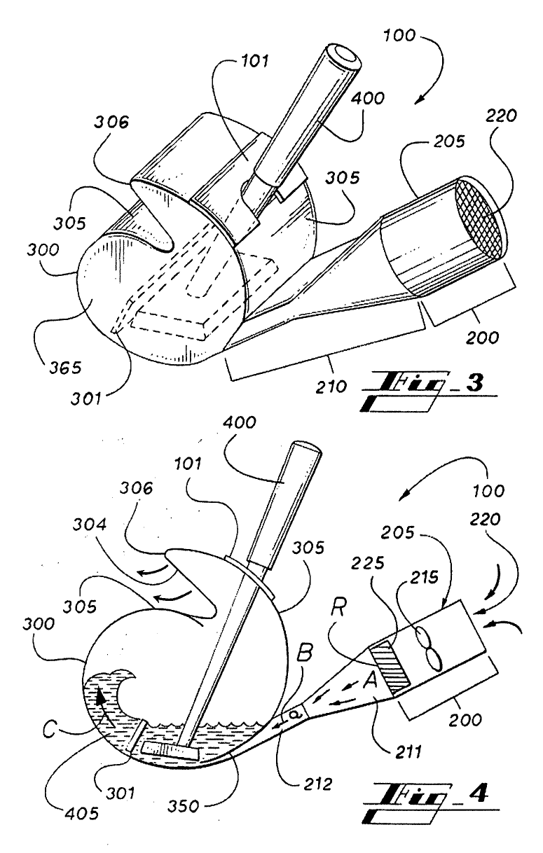

FIG. 3 illustrates a detailed rear angle perspective view of a razor drying system, similar to that of FIG. 1.

FIG. 4 illustrates a detailed side view of a razor drying system showing the recommended mechanism of operation thereof.

As shown in each of the Figures, and in a typical embodiment hereof, razor drying system 100 includes dryer 200 operatively coupled to curved-wall chamber 300 which includes a preferably unitary top, bottom, rear and front wall 305 which in cross-section form a smooth curve. Although such curve is shown in the embodiments hereof having a contour in the shape generally of a “comma”, as will be known to those skilled in the art, such curve can effectively be selected from a multiplicity of different shapes. Curved-wall chamber 300 has preferably a constant width, and with the width of curved-wall chamber 300 being slightly greater than the width of razor 400.

Dryer 200 generally includes housing 205 coupled to contraction duct 210, which, in turn is coupled to such curved-wall chamber 300. Curved-wall chamber 300 further comprises side walls 365, which are typically flat with their edges following the contours of curved-wall chamber 300. Housing 205 typically includes fan 215 for pulling intake air into housing 205 via air-intake 220 as indicated by arrows A of FIG. 4. Razor drying system 100 can include fan 215 or other equivalent air flow structure in a variety of desired orientations, such as being arranged horizontally as illustrated in the Figures hereof. In other embodiments, fan 215 can be arranged at an angle or arranged at a vertical or other orientation.

Disposed within curved-wall chamber 300 is optionally included debris filter 301, in which cleaning fluid 405 is dispersed through debris filter 301 while capturing unwanted debris. In preferred embodiments, cleaning fluid 405 preferably comprises water only, a water-based solution, alcohol based solutions, oil-based solutions, cleanser or soap additives, blade conditioning additives, and other fluids and combinations, although other such liquids may be utilized as may be determined by those skilled in the art. Debris filter 301 typically may extend across the entire width of curved-wall chamber 300. Furthermore, it is appreciated that debris filter 301 can optionally be removed for cleaning and replacement. Furthermore, disposed upon curved-wall chamber 300 is slot aperture 102 whereby the handle of razor 400 protrudes.

It has been determined that in some embodiments water might tend to leak from slot aperture 102 through which razor 400 protrudes. Hence, a slot door 101 may be preferably provided, which slot door 101 can be opened to allow insertion and removal of razor 400 and then closed when razor 400 is in place. Slot door 101 may take various forms, but in one preferred embodiment may be substantially rectangular to match the shape of slot aperture 102, but, however with a square or other suitably shaped cutout at the bottom thereof through which the handle of razor 400 protrudes. Accordingly, in the closed position, water is prevented from leaving such slot aperture 102 by slot door 101.

As shown in the Figures hereof, dryer 200 is preferably circular in cross-sectional shape. Furthermore, housing 205 may include a heating element 225, through which intake air can be directed as powered by fan 215 in order to heat such intake air (see Arrows A of FIG. 4) before it travels to contraction duct 210. However, it is appreciated that razor drying system 100 can function for its intended cleaning purposes with or without heating element 225. However, it is further appreciated that heating element 225 typically significantly accelerates the drying process as discussed further in the description below. It is generally also to be appreciated that housing 205 further includes a power source such as electrical current to provide power to fan 215 and power to heating element 225.

In general, fan 215 drives air through contraction duct 210, as shown by arrows B of FIG. 4, so that the air is thus directed to the lower region of curved-wall chamber 300. Whereupon, a closable cleaning valve typically which may be disposed near the intersection of hollow contraction duct 210 with the interior of curved-wall chamber 300 functions to facilitate drainage and cleaning of the chamber 300, whereby, for example, water or other flushing liquid may be directed, such as from a faucet or other means, through air exhaust aperture 304 into chamber 300 and out a cleaning valve for flushing and cleaning the interior of chamber 300.

In a typical embodiment, contraction duct 210 is a duct such that the flow of air is forced first through aperture 211 of contraction duct 210 having a first area R at the proximal end, and area a at the distal end thereof as defined by contraction duct aperture 212, and in which R>a. In this Venturi effect, the flow velocity through the contraction duct aperture 212 is increased from the initial velocity at aperture 211, thereby providing a greater exit velocity in which the (optionally) heated or warmed air is forced into curved-wall chamber 300 and circulated as shown by arrow C of FIG. 4. However, the “contraction duct” may or may not actually “contract” (that is, the area from R to a, in some embodiments might not be reduced, although the velocity of the air flowing therethrough would be commensurately reduced). Contraction Duct 210 can typically transition from a nearly circular shape typically at connection point to housing 205 and generally adjacent either fan 215 or heating element 225, to a more rectangular shape (or other shape) generally at the coupling point to curved-wall chamber 300, to exhaust into the curved-wall chamber 300 as discussed immediately above. It is appreciated that it is possible for the area of these two cross-sections to be the same. It is also appreciated that a variety of other cross sectional shapes are contemplated in other embodiments. However, in a typical embodiment, area reduction generally increases the effectiveness of the air flow by introducing a velocity differential, as described.

Curved-wall chamber 300 is generally arranged in some preferred embodiments such that continuous wall 305 generally spirals inwardly and towards itself. In this way, wall 315 is positioned toward the interior of curved-wall chamber 300. In typical embodiment, the side walls 365 of curved-wall chamber 300 can be flat, curved, or other shapes. Curved-wall chamber 300 further typically includes slot aperture 102 through which razor 400 is to be inserted into the interior of curved-wall chamber 300.

A user of razor drying system 100 can place a suitable cleaning fluid 405 into curved-wall chamber 300. Razor 400 is placed into and rests upon slot aperture 102. Once razor drying system 100 is activated, typically by providing power to fan 215 and to heating element 225, air is brought into air intake 220 via fan 215 as discussed above. The air then passes over preferable heating element 225 and directed into contraction duct 210. Hot air exhaust from powered fan 215 is forced though contraction duct 210 and into cleaning fluid 405. The high speed motion of the air/liquid combination within curved-wall chamber 300 provides a forced flow of heated air within and circulating the cleaning liquid, thus achieving cleaning action and debris removal from razor 400. Razor 400 is typically held stationary in curved wall chamber 300. A vane 350 may be attached to the bottom inside wall of the curved-wall chamber 300 and optionally positioned adjacent razor 400 to help hold the razor 400 in place (that is, to keep it from sliding away from the force of the exhaust). In preferring embodiments, vane 350, which in preferring embodiments may thus have various diverse sizes and shapes, may also preferably function to channel incoming air toward and directly upon the razor, and accordingly requires a suitable aperture thereunder for expelling the air flow therethrough. As such, vane 350 may be unitarily formed at least with the top portion of contraction duct 210 to provide a smooth flow of air therefrom.

As described above, inward portion of wall 315 of curved-wall chamber 300 promotes recirculation of cleaning fluid 405 (and air) within curved-wall chamber 300. By inward portion of wall 315 being positioned inward, air and cleaning fluid 405 are forced along the interior of wall 315 within curved-wall chamber 300 and directed to a back wall 360. When cleaning fluid 405 and air come into contact with back wall 360, cleaning fluid 405 generally flows under the force of gravity downwardly to be re-circulated in the same manner. The curvature of curved-wall chamber 300 further prevents flow of cleaning fluid 405 out of air exhaust aperture 304, yet allowing flow of air and fluid vapor into and out of chamber passively through air exhaust aperture 304.

During operation of razor drying system 100, cleaning fluid 405 may evaporate under the constant air flow as well as heat and razor 400 eventually dries under the flow. As described above, the evaporation and drying process is promoted by the flow of warm or hot air directly adjacent the head of razor 400. Such drying thus prevents a user from having to expel cleaning fluid 405 manually. In another embodiment, housing 205 can further include a timer mechanism, which can be programmable, coupled to the power source as well as fan 215 and heating element 225, such that fan 215 and heating element 225 is automatically powered off after operation for a specified period of time. In another embodiment, housing 205 can further include a moisture or humidity detector to automatically power off, once moisture is no longer detected within curved-wall chamber 300. In a typical implementation, debris can be forced and dried to the interior surface of curved-wall chamber 300, which can be removable for manual periodic cleaning. In another embodiment, debris can be forced and dried to a debris filter 301, which can be removable for manual periodic cleaning.

In other embodiments, it is appreciated that modifications to razor drying system 100 could be implemented for advantageously using razor drying system 100 for cleaning and drying items other than shaving razors. For example, razor drying system 100 could be implemented to clean toothbrushes, grooming, dental or other types of tools or items.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A razor maintenance system, comprising:
a central housing having a first end and a second end;
a duct coupled to said housing; and
a razor chamber coupled to said duct.

2. The system as claimed in claim 1, further comprising:
an intake vent disposed on the first end of said central housing; and
a fan positioned inside said central housing adjacent the intake vent, the fan for providing air from a source external to said housing, into said housing.

3. The system as claimed in claim 1, further comprising a heating element positioned adjacent the second end of said central housing and adjacent to a coupling point to said duct.

4. The system as claimed in claim 1, wherein said duct has a first end and a second end, said first end of said duct being coupled to said second end of said central housing.

5. The system as claimed in claim 4, further comprising an airflow pathway from said central housing to said duct.

6. The system as claimed in claim 4, wherein the first end of said duct has a first area A and said second end of said duct has a second area a.

7. The system as claimed in claim 6, wherein the relationship between said first area A and said second area a is selected from the group consisting of (a) greater than, and (b) equal to.

8. The system as claimed in claim 6, wherein said duct is a contraction duct.

9. The system as claimed in claim 5, further comprising an exhaust vent disposed on a coupling point between said second end of said duct and said razor chamber.

10. The system as claimed in claim 9, wherein said airflow pathway is defined from said intake vent, through said central housing, into said duct and through said exhaust vent.

11. The system as claimed in claim 1, wherein said razor chamber comprises curved side walls.

12. The system as claimed in claim 1, wherein said razor chamber comprises a razor slot for receiving a razor for positioning within said razor chamber.

13. The system as claimed in claim 12, further comprising a passive air exit disposed on said razor chamber.

14. The system as claimed in claim 13, further comprising a vane disposed on a lower interior surface of said razor chamber for receiving a razor head.

15. The system as claimed in claim 9, wherein said airflow pathway is defined from the intake vent, through said central housing, into said duct, through said exhaust vent, and through a generally circular pattern along an interior wall of said razor chamber.

16. The system as claimed in claim 15, wherein a razor positioned in said razor chamber includes a razor head positioned adjacent to said exhaust vent interfering with said air flow pathway.

17. A razor drying and cleaning kit, comprising:
a razor;
a cleaning and drying razor apparatus for receiving the razor; and
fluid for placement into said cleaning and drying apparatus.

18. The kit as claimed in claim 17, further comprising a forced airflow pathway for evaporating the fluid within said cleaning and drying razor apparatus, and generated from said cleaning and drying razor apparatus and into said razor head disposed within said cleaning and drying razor apparatus for cleaning said razor head.

19. The kit as claimed in claim 18, wherein said forced airflow pathway is for evaporating the fluid within said cleaning and drying razor apparatus.

20. The kit as claimed in claim 21, wherein said razor is for removal from said cleaning and drying razor apparatus when said razor head is cleaned and dried.

21. A cleaning and drying razor apparatus, comprising:
a housing;
means for providing an airflow, disposed within said housing;
means for providing heat into the airflow, disposed within said housing;
a chamber for cleaning and drying a razor disposed within said chamber, said chamber being coupled to said housing; and
means for directing the airflow from said housing into said chamber.

22. The apparatus as claimed in claim 21, further comprising means to alter the airflow disposed between said housing and said chamber.

23. A personal hygiene tool maintenance system, comprising
a central housing having a first end and a second end;
a duct coupled to said housing; and
a chamber coupled to said duct.

24. The system as claimed in claim 23, wherein said personal hygiene tool may be a toothbrush, comb, or a dental pick.

25. The system as claimed in claim 12, further comprising a rectangular slot wherein said rectangular slot is disposed in said curved side walls of said razor chamber is for protrusion of the handle of said razor.

26. The system as claimed in claim 1, further comprising a debris filter.

28. The system as claimed in claim 12, wherein said contraction duct has a rectangular end which is substantially the same width of curved side walled chamber.
